(19) United States
(12) Patent Application Publication
(10) Pub. No.: US 2008/0014968 A1
(43) Pub. Date: Jan. 17, 2008

(54) Apparatus and method for providing location information in mobile communication system

(75) Inventor: Seung-Il Yoon, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/822,636

(22) Filed: Jul. 9, 2007

(30) Foreign Application Priority Data
Jul. 10, 2006 (KR) 10-2006-0064264

(51) Int. Cl. H04Q 7/20

(52) U.S. Cl. 455/456.5

(57) ABSTRACT

An apparatus and method of providing location information in a mobile communication system are provided including steps for receiving a message by a Code Division Multiple Access (CDMA) 2000 1x Base Station (BS) and transmitting the received message to a 1x Evolution-Data Optimized (EV-DO) BS, wherein the message shows the location of the 1x BS and is transmitted from an Access Terminal (AT) sharing session information with the 1x EV-DO BS, updating, by the 1x EV-DO BS, information on the 1x BS according to the message including the location of the 1x BS, transmitting a paging request message from the 1x EV-DO BS to the 1x BS when a 1x EV-DO paging event is generated for the AT, generating a paging message by the 1x BS and transmitting it to the AT, and transmitting a message indicating the completion of a 1x service from the 1x BS to the 1x EV-DO BS when the AT ends the provision of the 1x service.

### CROSS-REFERENCE TO RELATED APPLICATION

This application claims the benefit under 35 U.S.C. §119(a) of Korean Patent Application No 10-2006-0064264, filed in the Korean Intellectual Property Office on Jul. 10, 2006, the entire disclosure of which is incorporated herein by reference.

### BACKGROUND OF THE INVENTION

1. Field of the Invention

The present invention relates to a mobile communication system. More particularly, the present invention relates to an apparatus and method for providing location information of a Code Division Multiple Access (CDMA) 2000 1x Base Station (BS) accessible by an Access Terminal (AT), and for delivering a paging request directly from a 1x EV-DO AN/PCF to an AT via a 1x BS when 1x EV-DO Data Over Signaling (DOS) paging is requested for delivering a 1x DOS payload or when 1x EV-DO DO paging is requested upon delivering a new packet for a 1x EV-DO packet session from a Packet Data Serving Node (PDSN) to the 1x EV-DO AN/PCF.

2. Description of the Related Art

FIG. 1 illustrates a DO paging process using a Code Division Multiple Access (CDMA) 2000 1x network according to the conventional art (hereinafter, “CDMA 2000 1x” will be referred to as simply “1x”).

FIG. 1 illustrates a signal exchange between a Mobile Station/Access Terminal (MS/AT) 110, a 1x Base Station (1xBS) 120, a Mobile Switching Center (MSC) 130, an HRPD AN/PCF 140 and a PDSN 150. Referring to FIG. 1, in the InterOperability Specification (IOS), the DO paging process is carried out in such a way that, according to a method provided by a vender, information that the Mobile Station/Access Terminal (MS/AT) 110 is currently receiving a 1x service is transmitted to a 1x Evolution-Data Optimized (EV-DO) Access Network (AN)/Packet Control Function (PCF) by the 1x Base Station (BS) 120 which is accessible by the MS/AT 110 connected to a dormant 1x EV-DO packet session. Herein, the 1x EV-DO AN/PCF is also known as the High Rate Packet Data (HRPD) AN/PCF 140. The DO paging or Data Over Signaling (DOS) paging procedure is defined under the premise that the 1x EV-DO AN/PCF knows the location of the 1x BS 120 accessible by the MS/AT 110.

However, the IOS does not define a procedure for delivering the location information of the 1x BS 120 or the MS/AT 110 to the 1x EV-DO AN/PCF having information on the dormant 1x EV-DO packet session connected to the AT while the 1x service is being provided to the MS/AT 110. As a result, the location information is delivered differently from one vender to another, which leads to compatibility problems.

To address these compatibility problems, the 1x BS 120 may deliver the location information to all surrounding 1x EV-DO AN/PCFs. By doing so, the 1x BS 120 can know whether the MS/AT 110 is connected to the dormant 1x EV-DO packet session. However, a problem still remains in that unnecessary location information may be frequently delivered. This is because overload (overhead) occurs when the location information is delivered to all 1x EV-DO AN/PCFs located in an overlay region. This problem can be solved by using a method in which DO paging or DO paging is requested when the 1x EV-DO AN/PCF requests the location information to the MS/AT. This method will be described with reference to FIG. 2.

FIG. 2 illustrates a DOS paging process using a 1x network according to the conventional art.

FIG. 2 illustrates a signal exchange between the Mobile Station/Access Terminal (MS/AT) 110, the 1x Base Station (1xBS) 120, a 1x MSC 132, an HRPD AN 142, an HRPD PCF 144 and the PDSN 150. Referring to FIG. 2, in the time sequences (B) and (C), the MS/AT 110 can receive a DOS or DO paging request via a Mobile Switching Center (MSC) by delivering a “Short Data Burst” message even when the MS/AT 110 is connected to the 1x BS 120.

The process of FIG. 2 employs a method in which DO or DOS paging is requested by referencing location information of a 1x network element (e.g., the MSC). In addition thereto, another method may be used in which a DO or DOS paging request is sent to all surrounding 1x BSs regardless of the presence of the location information.

However, these methods may result in excessive generation of the DO or DOS paging request, thereby wasting resources. In particular, the waste of resources is significant when considering a characteristic of a 1x network operation which is managed in the unit of an MSC instead of limiting a paging region to a specific 1x BS.

Accordingly, a need exists for a system and method for effectively and efficiently using resources when providing location information in a mobile communication system.

### SUMMARY OF THE INVENTION

Exemplary embodiments of the present invention are provided to substantially solve the above and other problems, and provide an apparatus and method for providing location information in a mobile communication system.

Exemplary embodiments of the present invention also provide an apparatus and method for delivering location information of a CDMA 2000 1x (hereinafter, “CDMA 2000 1x” will be referred to as simply “1x”) Base Station (BS) to a 1x Evolution-Data Optimized (EV-DO) Access Network (AN)/Packet Control Function (PCF) having information on a 1x dormant EV-DO packet session connected to an Access Terminal (AT), wherein the location information is used by a 1x EV-DO AN/PCF to enable a DO or Data Over Signaling (DOS) paging request through a traffic channel of the 1x BS.

Exemplary embodiments of the present invention also provide an apparatus and method for reducing a paging delay time by allowing a 1x EV-DO AN/PCF to directly request DO or DOS paging to a 1x BS without the aid of a Mobile Switching Center (MSC) when the 1x BS has its coverage overlaying that of the 1x EV-DO AN/PCF and thus, communication can be made with a direct connection.

According to one aspect of exemplary embodiments of the present invention, a method is provided for providing location information in the mobile communication system including steps for receiving a message by a 1x BS and transmitting the received message to a 1x EV-DO BS, wherein the message shows the location of the 1x BS and is transmitted from an AT sharing session information with the 1x EV-DO BS, updating, by the 1x EV-DO BS, information on the 1x BS according to the message including the location of the 1x BS, transmitting a paging request message from the 1x EV-DO BS to the 1x BS when a 1x EV-DO paging event is generated for the AT, generating a paging message by the 1x BS and transmitting it to the AT, and transmitting a message indicating the completion of a 1x service from the 1x BS to the 1x EV-DO BS when the AT ends the provision of the 1x service.

According to another aspect of exemplary embodiments of the present invention, an apparatus is provided for receiving a message by a 1x BS and transmitting the received message to a 1x EV-DO BS, wherein the message shows the location of the 1x BS and is transmitted from an AT sharing session information with the 1x EV-DO BS, updating, by the 1x EV-DO BS, information on the 1x BS according to the message including the location of the 1x BS, transmitting a paging request message from the 1x EV-DO BS to the 1x BS when a 1x EV-DO paging event is generated for the AT, generating a paging message by the 1x BS and transmitting it to the AT, and transmitting a message indicating the completion of a 1x service from the 1x BS to the 1x EV-DO BS when the AT ends the provision of the 1x service.

According to another aspect of exemplary embodiments of the present invention, an apparatus and method are provided for providing location information of a Code Division Multiple Access (CDMA) 2000 1x Base Station (BS) accessible by an Access Terminal (AT), wherein the location information is provided to a 1x Access Network (AN)/Packet Control Function (PCF) having information on a 1x Evolution-Data Optimized (EV-DO) packet session under the condition that the AT is connected to a dormant 1x EV-DO packet session and is in a traffic state in which a voice service is being provided from the 1x BS.

According to another aspect of exemplary embodiments of the present invention, an apparatus and method are provided for delivering a paging request directly from a 1x EV-DO AN/PCF to an AT via a 1x BS when 1x EV-DO Data Over Signaling (DOS) paging is requested for delivering a 1x DOS payload or when 1x EV-DO DO paging is requested upon delivering a new packet for a 1x EV-DO packet session from a Packet Data Serving Node (PDSN) to the 1x EV-DO AN/PCF under the condition that the AT is connected to a dormant 1x EV-DO packet session and receives a voice service from the 1x BS.

### BRIEF DESCRIPTION OF THE DRAWINGS

The above and other objects, features and advantages of the exemplary embodiments of present invention will become more apparent from the following detailed description when taken in conjunction with the accompanying drawings, in which:

FIG. 1 illustrates a DO paging process using a 1x network according to the conventional art;

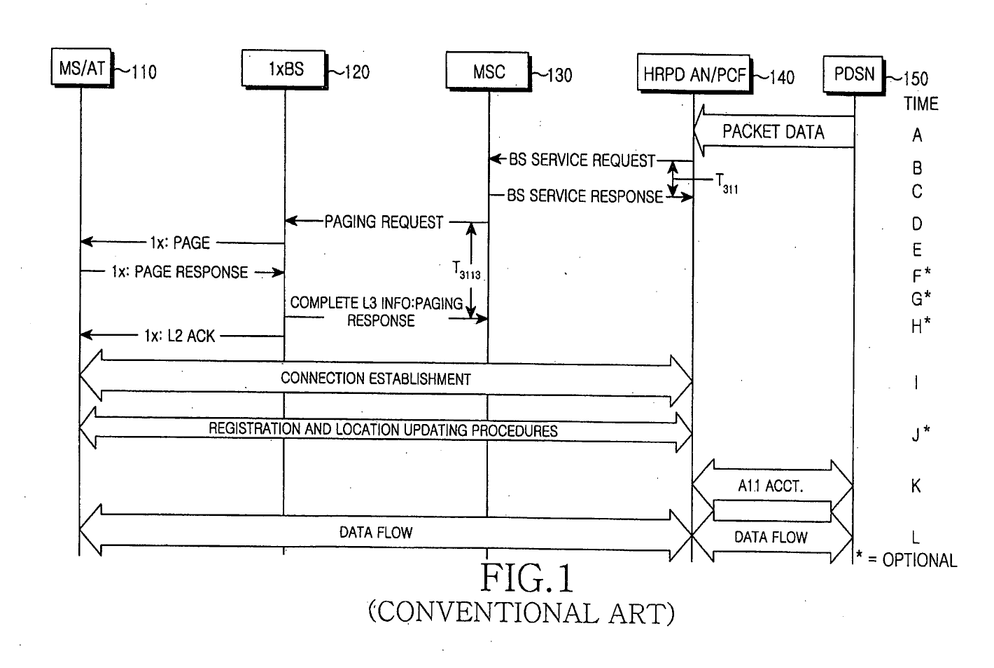

FIG. 2 illustrates a DOS paging process using a 1x network according to the conventional art;

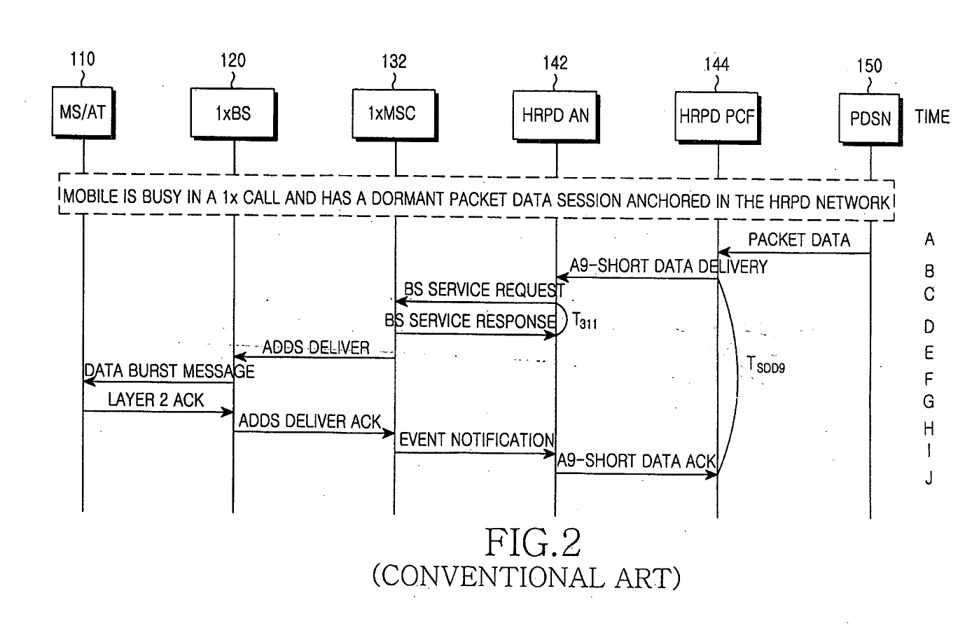

FIG. 3 illustrates a location information transfer process according to an exemplary embodiment of the present invention;

FIG. 4 illustrates a 1x DOS paging process according to an exemplary embodiment of the present invention;

FIG. 5 illustrates a process of changing a packet session from a 1x EV-DO packet session to a 1x packet session according to an exemplary embodiment of the present invention;

FIG. 6 illustrates a process of changing a packet session from a 1x EV-DO packet session to a 1x packet session when a voice call handoff occurs according to an exemplary embodiment of the present invention;

FIG. 7 is a block diagram of a BS used as a network device according to an exemplary embodiment of the present invention; and

FIG. 8 is a block diagram of an AT used as a network device according to an exemplary embodiment of the present invention.

Throughout the drawings, like reference numerals will be understood to refer to like parts, components and structures.

### DETAILED DESCRIPTION OF THE EXEMPLARY EMBODIMENTS

A number of exemplary embodiments of the present invention will be described herein below with reference to the accompanying drawings. In the following description, well-known functions or constructions are not described in detail since they would obscure the invention in unnecessary detail.

Exemplary embodiments of the present invention provide an apparatus and method for delivering location information of a CDMA 2000 1x (hereinafter, “CDMA 2000 1x” will be briefly referred to as simply “1x”) Base Station (BS) to a 1x Evolution-Data Optimized (EV-DO) Access Network (AN)/Packet Control Function (PCF) having information on a 1x dormant EV-DO packet session connected to an Access Terminal (AT), wherein the location information is used by a 1x EV-DO AN/PCF to enable a DO or Data Over Signaling (DOS) paging request through a traffic channel of the 1x BS. In addition, exemplary embodiments of the present invention also provide an apparatus and method for reducing a paging delay time by allowing a 1x EV-DO AN/PCF to directly request DO or DOS paging to a 1x BS without the aid of a Mobile Switching Center (MSC) when the 1x BS has its coverage overlaying that of the 1x EV-DO AN/PCF and thus communication can be made with a direct connection.

When a 1x EV-DO packet session of an AT enters into a dormant state while receiving a voice service from a 1x BS, location information of the 1x BS is delivered together with a Data Burst Message (DBM) to a 1x EV-DO AN/PCF to which the 1x EV-DO packet session has been recently established. The location information of the 1x BS is delivered to the 1x EV-DO AN/PCF, so that the 1x EV-DO AN/PCF can recognize the 1x BS which the AT can access. Then, a DOS or DO paging request can be delivered to the 1x BS.

The procedure of requesting DOS paging is similar to that of a 1x Short Data Burst (SDB) and is defined in the InterOperability Specification (IOS) supporting the 1x EV-DO Rev.A., as well as the procedure of requesting DO paging.

A 1x EV-DO high-speed data service and a 1x circuit voice service are expected to be provided together until a legacy 1x network over which the circuit voice service is provided is entirely replaced with a Voice over IP (VoIP) network.

In order to detect the generation of a paging request for a voice call, the AT periodically monitors a 1x paging channel regardless of a state (either a dormant state or a connected state) of a 1x EV-DO packet session. The AT establishes a voice call when a 1x voice service is requested during the dormant 1x EV-DO packet session or when a voice service paging request is received. In this case, a new packet to be transmitted to the AT in the dormant state can be delivered to the 1x EV-DO AN/PCF by requesting DO paging or DOS paging. In general, the DO paging or DOS paging request is carried out by the use of an MSC. However, in a case where a direct connection link exists between the 1x BS and the 1x EV-DO AN/PCF, the paging request may be directly sent from the 1x EV-DO AN/PCF to the 1x BS.

An exemplary technique will now be described in which location information of the 1x EV-DO AN/PCF is provided to the 1x BS after a 1x service session is established by the AT.

When a 1x EV-DO packet session is established to receive a high-speed data service, the AT may change from a 1x EV-DO mode (either dormant state or a connected state) to a 1x mode in the following two cases.

In the first case, as a result of monitoring a 1x paging channel in the dormant state, a voice call incoming request is received, or a user generates a voice call outgoing request. In the second case, upon receiving the voice call incoming request in the connected state, the 1x EV-DO packet session transitions to the dormant state, and voice call incoming is set to the 1x mode.

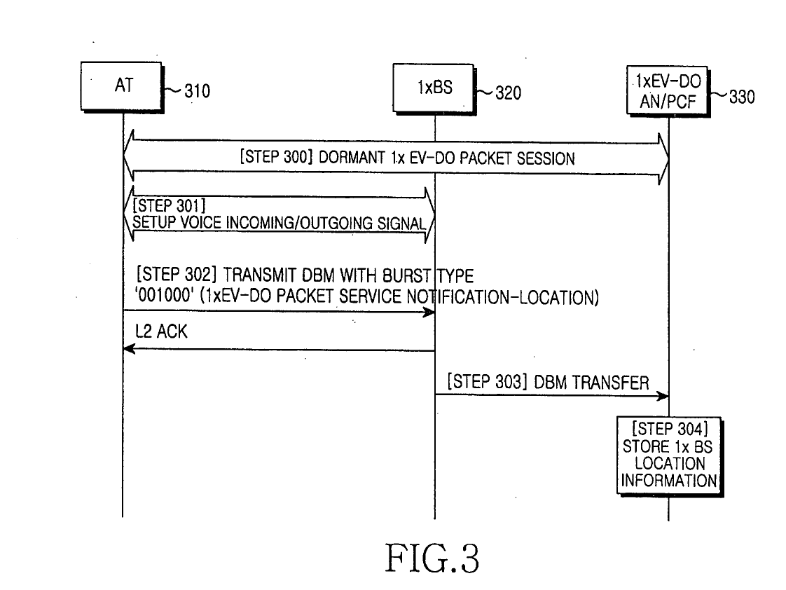

Once the AT is set to the 1x mode, there is no way for the 1x BS to detect the 1x EV-DO packet session. Conventionally, the 1x BS cannot provide its location information to the 1x EV-DO AN/PCF having information on the dormant 1x EV-DO packet session connected to the AT. In this case, the location information is only unilaterally delivered to the 1x EV-DO AN/PCF whose coverage overlays that of the 1x BS. To address this problem, there is a need for a technique in which the location information of the 1x BS is provided to the 1x EV-DO AN/PCF having information on the dormant 1x EV-DO packet session connected to the AT. An exemplary technique to do so will now be described below with reference to FIG. 3.

FIG. 3 illustrates a location information transfer process according to an exemplary embodiment of the present invention.

FIG. 3 illustrates a signal exchange between an Access Terminal (AT) 310, a 1x Base Station (1xBS) 320 and a 1x EV-DO AN/PCF 330. Referring to FIG. 3, immediately after being connected to a 1x network, if a 1x EV-DO packet session enters into a dormant state, the AT 310 delivers location information of the 1x EV-DO AN/PCF 330, which is connected to a 1x EV-DO packet session and has corresponding session information, together with a DBM. For this, in exemplary embodiments of the present invention, a new data burst type “001000”, i.e., “1x EV-DO Packet Service Notification-Location” is defined.

In step 300, the AT 310 is connected to the dormant 1x EV-DO packet session. In step 301, the AT 310 establishes a voice call connection through a 1x BS 320 when a voice call incoming/outgoing signal has to be setup in a 1x mode.

In step 302, the AT 310 transmits a DBM with a data burst type “001000” to the 1x BS 320 so as to provide notice of the fact that the 1x EV-DO packet session is in the dormant state. At this time, the location information of the 1x EV-DO AN/PCF 330 is also transmitted to the 1x BS 320. The burst type used in step 302 has a format as described by way of example in Table 1 below.

TABLE 1

| Burst Type | | Associated |
|---|---|---|
| (Binary) | Designed use/Type of service | Standards |
| 000000˜000111 | // Already defined | |
| 001000 | 1x EV-DO Packet Service Notification - | |
| | Location | |
| 001001 | 1x EV-DO Packet Service - DOS | |

| | |
|---|---|
| 111110˜111111 | // Already defined |

-Burst Type: 001000 format

| | | | |
|---|---|---|---|
| PREV_SID: | PREV_NID: | PREV_ZID: | Reserved: |
| 15 bits | 16 bits | 8 bits | 1 bit |

In Table 1, “PREV_SID” denotes a Previous System Identification, “PREV_NID” denotes a Previous Network Identification, and “PREV_ZID” denotes a Previous PacketZone Identification.

In step 303, the 1x BS 320 transfers the received DBM to the 1x EV-DO AN/PCF 330 having information on the 1x dormant EV-DO packet session connected to the AT 310.

In step 304, the 1x EV-DO AN/PCF 330 adds location information of the 1x BS 320 to the information on the dormant 1x EV-DO packet session.

An exemplary technique will now be described in which a 1x EV-DO AN/PCF directly requests DO or DOS paging to a 1x BS by using location information of the 1x BS.

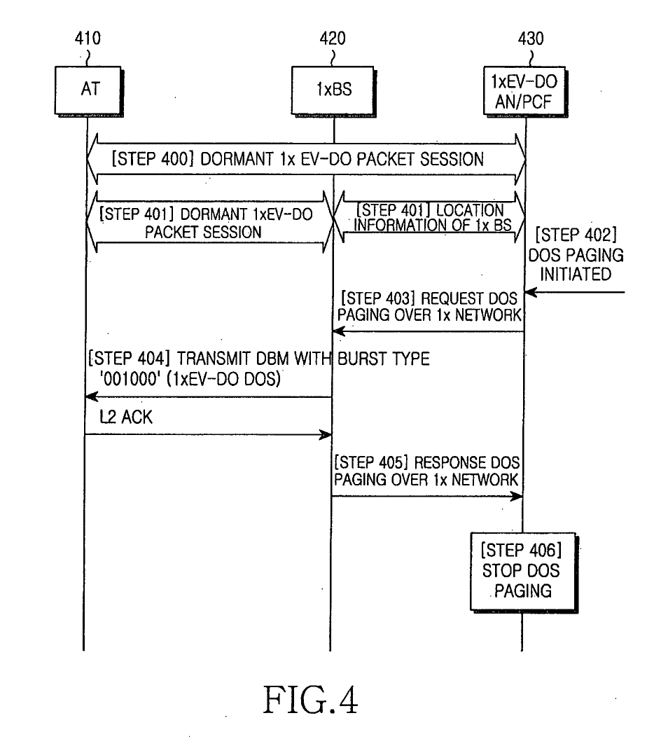

FIG. 4 illustrates a 1x DOS paging process according to an exemplary embodiment of the present invention.

FIG. 4 illustrates a signal exchange between an Access Terminal (AT) 410, a 1x Base Station (1xBS) 420 and a 1x EV-DO AN/PCF 430. Referring to FIG. 4, in step 400, an AT 410 is connected to a dormant 1x EV-DO session. In steps 401, the 1x EV-DO AN/PCF 430 receives from the 1x BS 420 a DBM transferred from the AT 410 and recognizes that the AT 410 is connected to the 1x BS 420. Steps 400 and 401 are similar to those described in FIG. 3.

In step 402, a packet needs to be transferred through the dormant 1x EV-DO packet session, or DOS paging is requested. Then, in step 403, the 1x EV-DO AN/PC 430 sends a DOS or DO paging request to the 1x BS 420.

If it is confirmed that the AT 410 is connected to the 1x BS 420, in step 404 the 1x BS 420 transfers a DBM (data burst type “000111”) to the AT 410 when the DO paging is requested, whereas the 1x BS 420 transfers a DBM (data burst type “001001”) to the AT 410 together with a DOS payload. The DMB (data burst type “001001”) has been described in Table 1 above. Exemplary embodiments of the present invention describe the use of the DMB (data burst type “001001”), which is transferred when the DOS paging is requested, and a DOS payload including in the DMB.

In step 405, upon receiving a Layer 2 Acknowledge (L2 Ack) message transferred from the AT 410 (or regardless of receiving it if the L2 Ack message is not necessary), the 1x BS 420 transfers to the 1x EV-DO AN/PCF 430 a message indicating the successful transfer of a response message for the DOS paging requested in step 404. In step 406, the 1x EV-DO AN/PCF 430 stops the transfer of the DOS paging request message when the message of step 405 shows that the L2 Ack message has been received.

If the message of step 404 indicates that the AT 410 requires a DOS access for DOS paging, a DBM (data burst type “001001”) is delivered to the 1x BS 420. Upon receiving the DBM (data burst type “001001”), the 1x BS 420 delivers the DMB (data burst type “001001”) to the 1x EV-DO AN/PCF 430.

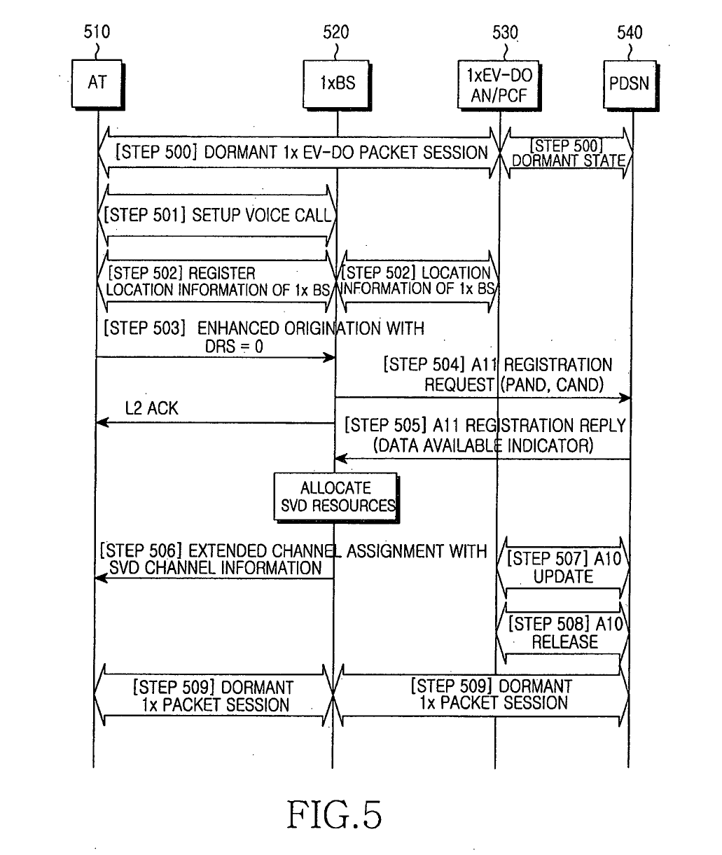

In a case where the AT 410 receives a paging request for a 1x EV-DO packet session while continuously receiving a 1x voice service, a packet session transitions from a dormant 1x EV-DO packet session to a dormant 1x packet session while a connected state with the 1x BS is maintained as shown in FIG. 5.

FIG. 5 illustrates a process of changing a packet session from a 1x EV-DO packet session to a 1x packet session according to an exemplary embodiment of the present invention.

FIG. 5 illustrates a signal exchange between an Access Terminal (AT) 510, a 1x Base Station (1xBS) 520, a 1x EV-DO AN/PCF 530 and a PDSN 540. Referring to FIG. 5, steps 500, 501 and 502 are similar to those described in FIG. 3. When the AT 510 is reconnected to a previously connected 1x EV-DO packet session, in step 503 a 1x message “Enhanced Origination with Data Ready Service (DRS) set to 0” is delivered to the 1x BS 520. Since the 1x BS 520 knows the existence of a dormant 1x EV-DO packet session using a DBM (data burst type “001000”), this message is delivered for a handoff from the dormant 1x EV-DO packet session to a dormant 1x packet session.

In this case, in step 504, by using a Packet Zone identification (PZID) and a Previous PZID (PREV_PZID) included in the message “Enhanced Origination” transmitted by the AT 510, the 1x BS 520 adds a Previous Access Network Identification (PANID) and a Current Access Network Identification (CANID) to a message “All Registration Request” to be transmitted to the PDSN 540.

Then, a channel between the AT 510 and the PDSN 540 changes to pass via the 1x BS 520 rather than the 1x EV-DO AN/PCF 530.

In step 505, if the request of the message “A11 Registration Request” is allowed, the PDSN 540 determines a specific lifetime of a message “A11 Registration Reply” and delivers the determined lifetime to the 1x BS 520.

If there is data to be transmitted, the PDSN 540 adds a data available indicator to the message “A11 Registration Reply”.

Upon receiving the data available indicator, the 1x BS 520 allocates a wired/wireless resource for setting Simultaneous Voice and Data (SVD) that supports both a voice service and a packet service. In step 506, the 1x BS 520 transmits a message “Extended Channel Assignment” for reestablishing a traffic channel to the AT 510.

After being connected to the 1x BS 520, in step 507 the PDSN 540 transmits a message “A11 Registration Update” so as to update the previous connection with the 1x EV-DO AN/PCF 530. Then, in response thereto, the 1x EV-DO AN/PCF 530 transmits a message “A11 Registration Acknowledge”.

Thereafter, to release the connection with the PDSN 540, in step 508 the 1x EV-DO AN/PCF 530 transmits the message “A11 Registration Request” to the PDSN 540 after setting its lifetime to 0.

In steps 509, the 1x BS 520 transitions to a dormant state if there is no traffic for a predetermined length of time after a service is provided through a packet session changed to a 1x mode.

When a handoff occurs in the process of providing a 1x voice call service, and thus the 1x BS cannot provide the 1x voice call service, as a result thereof, a handoff to the 1x EV-DO packet session occurs.

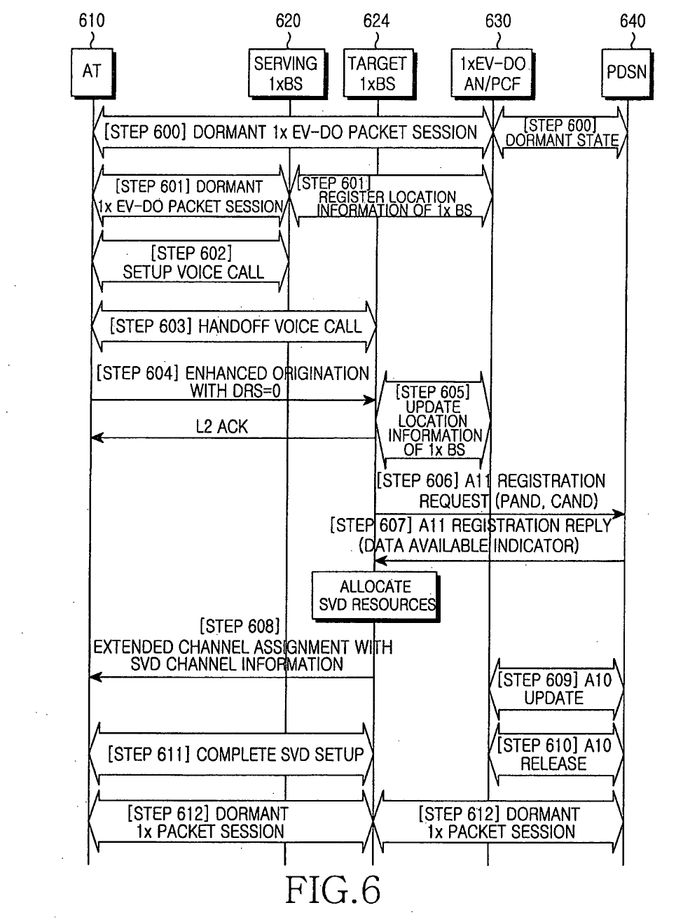

FIG. 6 illustrates a process of changing a packet session from a 1x EV-DO packet session to a 1x packet session when a voice call handoff occurs according to an exemplary embodiment of the present invention.

FIG. 6 illustrates a signal exchange between an Access Terminal (AT) 610, a Serving 1x Base Station (1xBS) 620, a Target 1x Base Station (1xBS) 624, a 1x EV-DO AN/PCF 630 and a PDSN 640. Referring to FIG. 6, steps 600, 601 and 602 are similar to those described in FIG. 3. In step 603, the AT 610 performs a voice call handoff from the serving 1x BS 620 to the target 1x BS 624. In exemplary embodiments of the present invention, it can be assumed for example that a hard handoff occurs between MSCs.

In step 604, the AT 610 transmits a message “Enhanced Origination (DRS=0)” to the target 1x BS 624 in order to perform a dormant state handoff for the dormant 1x EV-DO packet session.

In step 605, the target 1x BS 624 is subjected to a location information update process by the 1x EV-DO AN/PCF 630.

In this case, the serving 1x BS 620 knows the existence of the dormant 1x EV-DO packet session connected to the AT 610, by using a DBM (data burst type “001000”) when a voice call handoff occurs in step 603.

Then, the target 1x BS 624 can prepare to perform a handoff from a 1x EV-DO packet session to a dormant 1x packet session.

In this case, in step 606, by using a PZID and a PREV_PZID included in the message “Enhanced Origination” transmitted by the AT 610, the target 1x BS 624 adds a PANID and a CANID to a message “A11 Registration Request” to be transmitted to a PDSN 640.

In step 607, if the request of the message “A11 Registration Request” is allowed, the PDSN 640 determines a specific lifetime of a message “A11 Registration Reply” and delivers the determined lifetime to the target 1x BS 624.

If there is data to be transmitted, the PDSN 640 adds a data available indicator to the message “A11 Registration Reply”.

Upon receiving the data available indicator, the 1x BS 624 allocates a wired/wireless resource for setting SVD that supports both a voice service and a packet service. In step 608, the 1x BS 624 transmits a message “Extended Channel Assignment” for reestablishing a traffic channel to the AT 610.

After being connected to the target 1x BS 624, in step 609 the PDSN 640 transmits a message “A11 Registration Update” so as to update the previous connection with the 1x EV-DO AN/PCF 630. Then, in response thereto, the 1x EV-DO AN/PCF 630 transmits a message “Al I Registration Acknowledge”.

Thereafter, to release the connection with the PDSN 640, in step 610 the 1x EV-DO AN/PCF 630 transmits the message “A11 Registration Request” to the PDSN 640 after setting its lifetime to 0.

In step 611, the target 1x BS 624 is changed from the 1x EV-DO packet session to the 1x packet session by setting SVD. In steps 612, if a service packet does not exist for a predetermined length of time, the 1x packet session transitions to the dormant state.

An exemplary technique will now be described in which a 1x EV-DO AN/PCF is informed whether to release a 1x service when a 1x BS releases the 1x service.

With being connected to a dormant 1x EV-DO packet session, an AT delivers location information to a 1x EV-DO/PCF via a 1x BS whose coverage overlays that of the AT by using a DBM. Likewise, when a 1x service is completely provided to the AT, the 1x BS notifies this information to the 1x EV-DO AN/PCF.

By doing so, even after the AT changes again to the 1x EV-DO mode, unnecessary DO or DOS paging request can be avoided when the 1x AN/PCF misunderstands that the AT operates in the 1x mode, thereby preventing any waste of resources.

An exemplary network device and an AT which employ the technology of exemplary embodiments of the present invention will now be described.

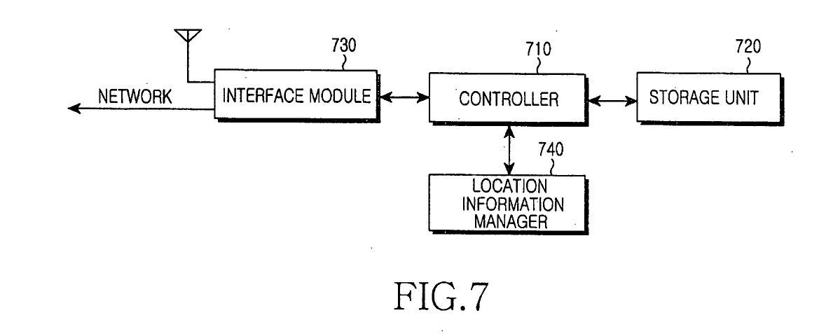

FIG. 7 is a block diagram of a BS used as a network device according to an exemplary embodiment of the present invention.

The BS can comprise a typical BS function and/or a control station function, but is not limited thereto. Referring to FIG. 7, the BS comprises an interface module 730, a controller 710, a storage unit 720, and a location information manager 740. The controller 710 provides the overall control of the BS. Specifically, the controller 710 controls voice calls and data communications. According to exemplary embodiments of the present invention, in addition to its typical functions, the controller 710 allows the location information manager 740 to control location information, and also allows the interface module 730 to receive information provided by the location information manager 740. Furthermore, the controller 710 allows the location information manager 740 to receive information received by the interface module 730.

Under the control of the controller 710, if the BS is the 1x BS, the location information manager 740 provides the information transmitted by the AT using the DBM to the controller 710 so that the 1x BS transmits the location information to the 1x EV-DO AN/PCF.

When the AT allows the 1x EV-DO session to transition from a dormant state to an active state, the connection between the PDSN and the 1x EV-DO AN/PCF having information on the 1x EV-DO session is changed to a different connection between the PDSN and the 1x BS. This process is also applied after the AT performs a handoff for a voice call.

If the BS is the 1x AN/PCF, according to the location information transmitted by the 1x BS, the DO or DOS paging request is sent to the 1x BS. When the PDSN requests the AT to transition to the 1x EV-DO session, a corresponding process is performed so that the session is reestablished to the 1x BS.

The storage unit 720 stores a program for controlling overall operations of the BS and temporary data produced during the execution of the program.

The interface module 730 is used to communicate with the higher layer network device or the AT. For communication with the AT, the interface module 730 comprises a Radio Frequency (RF) processor and a baseband processor. The RF processor converts a signal received through an antenna into a baseband signal, and provides the baseband signal to the baseband processor. Thereafter, the baseband signal is converted to an RF signal so as to be transmitted over the air, and the RF signal is transmitted through the antenna. For example, when a CDMA scheme is used, data to be transmitted is subjected to channel-coding and spreading, and data to be received is subjected to de-spreading and channel-decoding. The module for communication with the higher layer network comprises a baseband processor and a wired processor. A physical transmission interface used by the wired processor may employ a variety of techniques including optical communication.

According to the aforementioned exemplary structure, the controller 710 controls the location information manager 740. Although depicted separately in FIG. 7, this is for description purpose only. Thus, in yet other embodiments of the present invention, functions of the location information manager 740 may be entirely or partially performed by the controller 710.

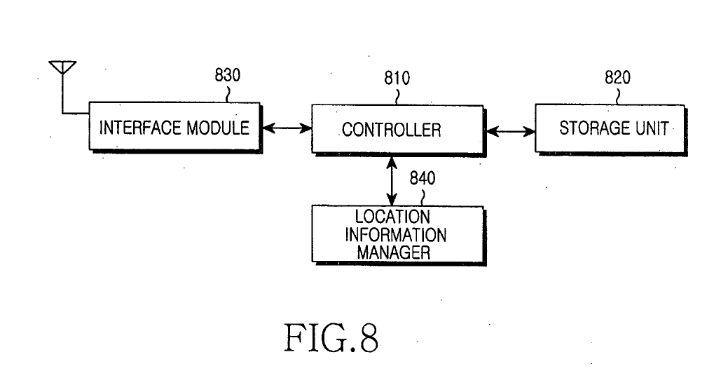

FIG. 8 is a block diagram of an AT used as a network device according to an exemplary embodiment of the present invention.

Referring to FIG. 8, the AT comprises an interface module 830, a controller 810, a storage unit 820, and a location information manager 840. The controller 810 provides the overall control of the AT. Specifically, the controller 810 controls voice calls and data communications. According to exemplary embodiments of the present invention, in addition to its typical functions, the controller 810 allows the location information manager 840 to control location information, and also allows the interface module 830 to receive information provided by the location information manager 840. Furthermore, the controller 810 allows the location information manager 840 to receive information received by the interface module 830.

When the AT has information on a dormant 1x EV-DO session and receives a 1x mode service under the control of the controller 810, the location information manager 840 transmits to the controller 810 location information to be transmitted to the 1x BS. Further, the location information manager 840 requests the packet session to transition from the dormant state to the connection state. The request may also be applied even after the AT performs a voice call handoff.

The storage unit 820 stores a program for controlling overall operations of the BS and temporary data produced during the execution of the program.

The interface module 830 is used to communicate with the higher layer network device or the AT. For communication with the AT, the interface module 830 comprises an RF processor and a baseband processor. The RF processor converts a signal received through an antenna into a baseband signal, and provides the baseband signal to the baseband processor. Thereafter, the baseband signal is converted to an RF signal so as to be transmitted over the air, and the RF signal is transmitted through the antenna. For example, when a CDMA scheme is used, data to be transmitted is subjected to channel-coding and spreading, and data to be received is subjected to de-spreading and channel-decoding.

According to the aforementioned exemplary structure, the controller 810 controls the location information manager 840. Although depicted separately in FIG. 8, this is for description purpose only. Thus, in yet other embodiments of the present invention, functions of the location information manager 840 may be entirely or partially performed by the controller 810.

According to the exemplary embodiments of present invention, an AT having information on a dormant 1x EV-DO packet session transmits a DBM to a 1x BS, wherein the DBM shows that the AT is connected to a 1x network. Further, location information of the 1x BS accessible by the AT is provided to a 1x EV-DO AN/PCF having information on the 1x EV-DO packet session so that, when requested to the AT, a DO or DOS paging request can be directly sent to the 1x BS without the aid of an MSC, thereby reducing a paging delay time.

In addition, while the AT is receiving a 1x voice service, a dormant state handoff is carried out from a previous connected 1x EV-DO packet session to a 1x packet session. Since the 1x packet session can be reutilized, a voice service and a packet service can be simultaneously provided.

In addition, when a voice call is released while an AT is receiving a 1x voice service, a 1x BS provides notice of the release of voice call to a 1x EV-DO AN/PCF, thereby avoiding unnecessary DO or DOS paging request.

While the present invention has been shown and described with reference to certain exemplary embodiments thereof, it will be understood by those skilled in the art that various changes in form and detail may be made therein without departing from the spirit and scope of the invention as defined by the appended claims and their equivalents.

What is claimed is:

1. A method of providing location information in a mobile communication system, comprising the steps of:
receiving a message, by a first mode Base Station (BS), from an Access Terminal (AT) and transmitting the received message to a second mode BS based on the received message, wherein the message includes the location of the second mode BS and is transmitted from the AT sharing session information with the second mode BS;
updating, by the second mode BS, information on the first mode BS based on the message;
transmitting a paging request message, by the second mode BS to the first mode BS when a second mode paging event for the AT is received;
generating a paging message, by the first mode BS, and transmitting it to the AT; and
transmitting a message indicating the completion of a first mode service, by the first mode BS, to the second mode BS when the AT ends the first mode service.

2. The method of claim 1, wherein the first mode is a Code Division Multiple Access (CDMA) 2000 1x mode, and the second mode is a CDMA 2000 1x Evolution-Data Optimized (EV-DO) mode.

3. The method of claim 1, wherein the message including the location of the second mode BS includes at least one of a previous system identification, a previous network identification, and a previous network identification.

4. The method of claim 1, wherein the message including the location of the second mode BS is a Data Burst Message (DBM).

5. A method of providing location information of a voice mode Base Station (BS) in a mobile communication system, comprising the steps of:
receiving a message including the location of a data mode BS from an Access Terminal (AT) sharing session information with the data mode BS;
determining the data mode BS from the message;
transmitting the message to the data mode BS;
receiving a data mode paging request message for the AT from the data mode BS;
transmitting a paging message to the AT; and
transmitting a message indicating the completion of a voice mode service to the data mode BS when the AT ends the voice mode service.

6. The method of claim 5, wherein the voice mode is a Code Division Multiple Access (CDMA) 2000 1x mode, and the data mode is a CDMA 2000 1x Evolution-Data Optimized (EV-DO) mode.

7. The method of claim 5, wherein the message including the location of the data mode BS includes at least one of a previous system identification, a previous network identification, and a previous network identification.

8. The method of claim 5, wherein the message including the location of the data mode BS is a Data Burst Message (DBM).

9. A method of changing a data session mode for an Access Terminal (AT) in a mobile communication system, comprising the steps of:
transmitting a message including the location of a second mode Base Station (BS) from the AT sharing session information with the second mode BS to the first mode BS;
recognizing the location of the second mode BS based on the message including the location of the second mode BS;
transmitting a message, by which the data session mode is changed from the second mode to the first mode, from the AT to the first mode BS;
transmitting a channel change message from the first mode BS to a Packet Data Service Node (PDSN), and changing, by the PDSN, a data session channel between the PDSN and the second mode BS to a data session channel between the PDSN and the first mode BS; and
setting an environment in which the first mode BS provides both a voice service and a data service to the AT, and reallocating a traffic channel to the AT.

10. The method of claim 9, wherein the first mode is a Code Division Multiple Access (CDMA) 2000 1x mode, and the second mode is a CDMA 2000 1x Evolution-Data Optimized (EV-DO) mode.

11. The method of claim 9, wherein the message including the location of the second mode BS includes at least one of a previous system identification, a previous network identification, and a previous network identification.

12. The method of claim 9, wherein the message including the location of the second mode BS is a Data Burst Message (DBM).

13. The method of claim 9, further comprising releasing a data session channel between the second mode BS and the PDSN.

14. An apparatus of a Base Station (BS) for providing location information in a mobile communication system, comprising:
a location information manager for receiving a message including the location of a second mode BS from an Access Terminal (AT), and
if a paging request event is received for the AT, for generating a message including the paging request event and transmitting the message to a second mode BS, and
if the message including the paging request event is received, for generating a paging message and transmitting it to the AT, and
if the AT ends a first mode service, for generating a message including the completion of the service and transmitting it to the second mode BS, and
if a data session change request is received from the AT, for generating a data session change message and transmitting it to a Packet Data Service Node (PDSN) so as to change a data session, and
for generating a message to reallocate a traffic channel and transmitting it to the AT, and for generating and transmitting a message to transmit data session information from the AT to a target first mode BS comprising coverage into which the AT moves during a handoff for a voice call; and
a controller for controlling the location information manager to manage location information, to transmit a message generated by the location information manager, and to provide the received message to the location information manager.

15. The apparatus of claim 14, wherein the first mode is a Code Division Multiple Access (CDMA) 2000 1x mode, and the second mode is a CDMA 2000 1x Evolution-Data Optimized (EV-DO) mode.

16. The apparatus of claim 14, wherein the message including the location of the second mode BS is a Data Burst Message (DBM).

17. The apparatus of claim 14, wherein the message including the location of the second mode BS includes at least one of a previous system identification, a previous network identification, and a previous network identification.

18. The apparatus of claim 14, wherein the paging message includes content of the paging request event.

19. The apparatus of claim 14, wherein the paging message is a DBM.

20. An apparatus of an Access Terminal (AT) for providing location information in a mobile communication system, comprising:
a location information manager for generating and transmitting a message including the location of a second mode Base Station (BS) if the AT has information on a second mode data session and receives a first mode service, and for receiving a second mode paging message when in the first mode and requesting the data session to be changed from the second mode to the first mode; and
a controller for controlling the location information manager to manage location information, to transmit a message generated by the location information manager, and to provide the received message to the location information manager.

21. The apparatus of claim 20, wherein the message including the location of the second mode BS includes at least one of a previous system identification, a previous network identification, and a previous network identification.

22. The apparatus of claim 20, wherein the message including the location of the second mode BS is a Data Burst Message (DBM).

23. The apparatus of claim 20, wherein the paging message includes content of the paging request event.

24. The apparatus of claim 20, wherein the paging message is a DBM.

25. The apparatus of claim 20, wherein the first mode is a Code Division Multiple Access (CDMA) 2000 1x mode, and the second mode is a CDMA 2000 1x Evolution-Data Optimized (EV-DO) mode.

26. A system for providing location information in a mobile communication system, comprising:
an Access Terminal (AT) for generating and transmitting a message including the location of a second mode Base Station (BS) if the AT has information on a second mode data session and receives a first mode service, and for receiving a second mode paging message when in the first mode and requesting the data session to be changed from the second mode to the first mode; and
the first mode BS for generating a paging message including paging information and transmitting it to the AT, and for requesting a Packet Data Service Node (PDSN) to change a data session to a second mode data session upon receiving a request from the AT and changing the data session if the message requesting the data session to be changed from the second mode to the first mode from the AT, and a paging request message is received from the second mode BS; and
the second mode BS for receiving the message including the location of the second mode BS, if a paging request event is generated for the AT, for transmitting the paging request message to the first mode BS, and for releasing a previous connection session with the PDSN.

27. The system of claim 26, wherein the first mode is a Code Division Multiple Access (CDMA) 2000 1x mode, and the second mode is a CDMA 2000 1x EV-DO mode.

28. The system of claim 26, wherein the message including the location of the second mode BS includes at least one of a previous system identification, a previous network identification, and a previous network identification.

29. The system of claim 26, wherein the message including the location of the second mode BS is a Data Burst Message (DBM).

30. The system of claim 26, wherein the paging message includes content of the paging request event.

31. The system of claim 26, wherein the paging message is a DBM.

32. A method of a data mode Base Station (BS) for providing location information in a mobile communication system, comprising the steps of:
determining the location of a voice mode BS based on a received message from the voice mode BS.
updating, based on the received message, information on an Access Terminal (AT) and information on the voice mode BS accessible by the AT;
if a data mode paging request event for the AT is received, transmitting a paging request message to the voice mode BS; and
if a completion information of a voice mode service for the AT from the voice mode BS, is received, updating the information on the AT based on the completion information.

33. The method of claim 32, wherein the voice mode is a Code Division Multiple Access (CDMA) 2000 1x mode, and the data mode is a CDMA 2000 1x Evolution-Data Optimized (EV-DO) mode.

34. The method of claim 32, wherein the received message includes at least one of a previous system identification, a previous network identification, and a previous network identification.

35. The method of claim 32, wherein the received message is a Data Burst Message (DBM).

36. A method of an Access Terminal (AT) for providing location information in a mobile telecommunication system, comprising the steps of:
generating and transmitting a message including the location of a second mode Base Station (BS) if the AT has information on a second mode data session and receives a first mode service; and
receiving a second mode paging message when the AT is in the first mode.

37. The method of claim 36, wherein the message including the location of the second mode BS includes at least one of a previous system identification, a previous network identification, and a previous network identification.

38. The method of claim 36, wherein the message including the location of the first mode BS is a Data Burst Message (DBM).

39. The method of claim 36, wherein the paging message includes content of the paging request event.

40. The method of claim 36, wherein the paging message is a DBM.

41. The method of claim 36, wherein the first mode is a Code Division Multiple Access (CDMA) 2000 1x mode, and the second mode is a CDMA 2000 1x Evolution-Data Optimized (EV-DO) mode.

42. An apparatus of providing location information of a voice mode Base Station (BS) in a mobile communication system, comprising;
means for receiving a message including the location of a data mode BS from an Access Terminal (AT) sharing session information with the data mode BS;
means for determining the data mode BS from the message;
means for transmitting the message to the data mode BS;
means for receiving a data mode paging request message for the AT from the data mode BS;
means for transmitting a paging message to the AT; and
means for transmitting a message indicating the completion of a voice mode service to the data mode BS when the AT ends the voice mode service.

43. The apparatus of claim 42, wherein the voice mode is a Code Division Multiple Access (CDMA) 2000 1x mode, and the data mode is a CDMA 2000 1x Evolution-Data Optimized (EV-DO) mode.

44. The apparatus of claim 42, wherein the message including the location of the data mode BS includes at least one of a previous system identification, a previous network identification, and a previous network identification.

45. The method of claim 42, wherein the message including the location of the data mode BS is a Data Burst Message (DBM).

46. An apparatus of a data mode Base Station (BS) for providing location information in a mobile communication system, comprising the steps of:
means for determining the location of a voice mode BS based on a received message from the voice mode BS;;
means for updating, based on the received message, information on an Access Terminal (AT) and information on the voice mode BS accessible by the AT;
means for transmitting a paging request message to the voice mode BS if a data mode paging request event for the AT is received; and
means for updating the information on the AT based on the completion information, if a completion information of a voice mode service for the AT from the voice mode BS, is received.

47. The apparatus of claim 46, wherein the voice mode is a Code Division Multiple Access (CDMA) 2000 1x mode, and the data mode is a CDMA 2000 1x Evolution-Data Optimized (EV-DO) mode.

48. The apparatus of claim 46, wherein the received message includes at least one of a previous system identification, a previous network identification, and a previous network identification.

49. The apparatus of claim 46, wherein the received message is a Data Burst Message (DBM).

50. A system of providing location information in a mobile communication system, comprising;
an Access Terminal (AT) for sending a message wherein the message includes the location of a second mode Base Station (BS) and includes the AT sharing session information with the second mode BS;
a first mode BS for receiving the message and transmitting the received message to the second mode BS, generating a paging message and transmitting it to the AT when paging request message is received from the second BS, transmitting a message indicating the completion of a first mode service to the second mode BS when the AT ends the first mode service; and
the second mode BS for updating information on the first mode BS based on the message including the location of the second mode BS, transmitting a paging request message to the first mode BS when a second mode paging event for the AT is received.

51. The system of claim 50, wherein the first mode is a Code Division Multiple Access (CDMA) 2000 1x mode, and the second mode is a CDMA 2000 1x Evolution-Data Optimized (EV-DO) mode.

52. The system of claim 50, wherein the message including the location of the second mode BS includes at least one of a previous system identification, a previous network identification, and a previous network identification.

53. The system of claim 50, wherein the message including the location of the second mode BS is a Data Burst Message (DBM).
